(19) United States
(12) Patent Application Publication
(10) Pub. No.: US 2025/0109053 A1
(43) Pub. Date: Apr. 3, 2025

(54) METHOD FOR MANUFACTURING ASPHERICAL PRISM AND ASPHERICAL PRISM

(71) Applicant: AAC Optics (Chongqing) Co., Ltd., Chongqing (CN)

(72) Inventors: Feng Zhang, Shenzhen (CN); Rongguan Zhou, Shenzhen (CN)

(21) Appl. No.: 17/922,605

(22) PCT Filed: Jul. 27, 2022
(86) PCT No.: PCT/CN2022/108328

§ 371 Date: Nov. 19, 2024

(30) Foreign Application Priority Data
Mar. 30, 2022 (CN) 202210327423.9

(51) Int. Cl. C03B 23/00; B24B 13/06; B24B 49/02

(52) U.S. Cl. CPC C03B 23/0013; B24B 13/06; B24B 49/02; C03B 2215/11; C03B 2215/404; C03B 2215/406; C03B 2215/46

(57) ABSTRACT

The present disclosure provides a method for manufacturing an aspherical prism and an aspherical prism. The method includes step S1, forming a prism and a lens into one piece to obtain a forming body glass by using a hot-pressing molding; step S2, adhering the forming body glass to a tooling, and performing a right-angle surface milling on the forming body glass according to a preset size while reserving a processing amount for a polishing process; step S3, adhering the forming body glass formed after the right-angle surface milling to an optical backing plate for polishing; step S4, cutting the forming body glass formed after the polishing; step S5, coating the forming body glass formed after the cutting; and step S6, inking the forming body glass formed after the coating. The method can improve the structural precision and processing efficiency of the aspherical prism.

### TECHNICAL FIELD

The present disclosure relates to the field of optical technology, in particular, to a method for manufacturing an aspherical prism and an aspherical prism.

### BACKGROUND

The aspherical prism usually includes a lens (a convex lens or a concave lens) and a prism.

During the manufacturing of the aspherical prism, a triangular prism is usually assembled with a prism, and aspherical prisms with different specifications can be obtained by assembling different triangular prisms with lenses with different specifications. In different application scenarios, different assembly methods can be adopted. For example, the triangular prism and the lens can be glued into one piece by gluing. In the process of assembling the optical lens, a support can be used to support, thereby achieving the assembly. However, no matter what kind of assembly method is adopted, the accuracy requirements of the matching clearance and components, and the assembly accuracy requirements are very high.

Since the triangular prism and the lens are processed by different equipment, and the milling, polishing, cutting, coating, inking and other processes are completed separately on the optical equipment, and in the whole process, the processing cycle is relatively long, the processing efficiency is low, the precision control is unable to be consistent, and the size varied greatly.

Therefore, the above problems need to be solved.

### SUMMARY

### Technical Problem

The present disclosure provides a method for manufacturing an aspherical prism and an aspherical prism, which can improve the structural accuracy of the aspherical prism.

### SOLUTION TO SOLVE THE PROBLEM

### Technical Solution

To achieve the above aim, in a first aspect, some embodiments of the present disclosure provide a method for manufacturing an aspherical prism, and the method includes steps:
S1, forming a prism and a lens into one piece to obtain a forming body glass by using a hot-pressing molding;
S2, adhering the forming body glass to a tooling, and performing a right-angle surface milling on the forming body glass according to a preset size while reserving a processing amount for a polishing process;
S3, adhering the forming body glass formed after the right-angle surface milling to an optical backing plate for polishing;
S4, cutting the forming body glass formed after the polishing;
S5, coating the forming body glass formed after the cutting; and
S6, inking the forming body glass formed after the coating.

As an improvement, at step S1, the hot-pressing molding is performed with a precision tungsten steel mold.

As an improvement, at the S2, the processing amount for the polishing process is greater than or equal to 20 μm, and a milling surface finish level reaches ∇8.

As an improvement, the step S3 includes:
S31, when adhering the forming body glass to the optical backing plate, observing interference fringes with a standard mirror to confirm that a number of the interference fringes is within a preset range.

As an improvement, the step S3 includes:
S32, during the polishing process, monitoring a grinding size at time intervals to confirm that the grinding size is within a preset range.

As an improvement, the step S3 includes:
S30, during polishing a surface of 45°, using an optical backing plate of 45°.

As an improvement, at step S3, the polishing process is continuously performed without an off state.

As an improvement, the step S4 includes:
S41, adhering a reference glass plate to a cutting tooling, and cutting out a line mark on the reference glass plate as a reference line, and adhering the forming body glass after polishing to the reference glass plate in alignment with the reference line;
S42, cutting the forming body glass after the polishing with a cutting machine after a glue is cured; and
S43, after the cutting is completed, removing the glue to obtain the aspherical prism.

As an improvement, at step S41, a multi-line cutting machine is used to cut the line mark, and the multi-line cutting machine is used for cutting.

In a second aspect, the present disclosure provides an aspherical prism, and the aspherical prism includes: a first surface and a second surface that are perpendicular to each other; and a reflective surface connecting the first surface with the second surface. At least one of the first surface or the second surface is an aspherical surface. The aspherical prism is manufactured by the above any one method.

### BENIFITIAL EFFECT OF THE PRESENT DISCLOSURE

### Benifitial Effect

Compared with the related art, in the aspherical prism provided in the present disclosure, the triangular prism and the lens are formed into one piece by hot-pressing molding. In the subsequent milling, polishing, coating, inking, and other processes, all the processes are carried out simultaneously with a same standard. Therefore, while the processing efficiency is improving, the precision control is unified, and the size fluctuation is small. Since the triangular prism and the lens are formed into one piece by hot-pressing molding, the subsequent processing is also performed on the triangular prism and the lens that are formed into one piece, Thus, there is no assembly error, and the structural accuracy of the aspherical prism can be improved.

### BRIEF DESCRIPTION OF DRAWINGS

### Description of Drawings

In order to illustrate the technical solutions in the embodiments of the present disclosure more clearly, the following briefly introduces the accompanying drawings used in the description of the embodiments. The drawings in the following description are only some embodiments of the present disclosure. For those of ordinary skill in the art, other drawings can also be obtained from these drawings.

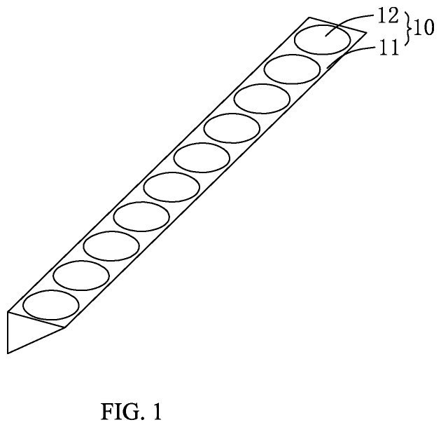

FIG. 1 is a schematic diagram of a forming body glass according to some embodiments of the present disclosure.

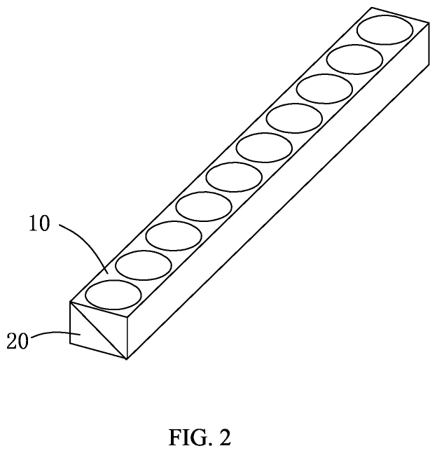

FIG. 2 is a schematic diagram illustrating adhering a forming body glass to a tooling according to some embodiments of the present disclosure.

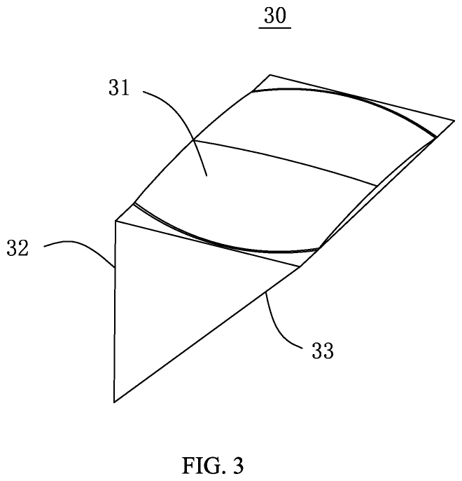

FIG. 3 is a schematic diagram of an aspherical prism obtained after cutting according to some embodiments of the present disclosure.

### DETAILED DESCRIPTION OF EMBODIMENTS

### Implementations of the Present Disclosure

The technical solutions in the embodiments of the present disclosure are clearly and completely described below with reference to the drawings in the embodiments of the present disclosure. The embodiments described are only some of the embodiments of the present disclosure, rather than all of the embodiments of the present disclosure. All other embodiments obtained by a person skilled in the art based on the embodiments in the present disclosure should fall within the scope of the present disclosure.

The present disclosure provides a method for manufacturing an aspherical prism, the method includes steps:
S1, forming a prism and a lens into one piece to obtain a forming body glass by using a hot-pressing molding;
S2, adhering the forming body glass to a tooling, and performing a right-angle surface milling on the forming body glass according to a preset size while reserving a processing amount for a polishing process;
S3, adhering the forming body glass formed after the right-angle surface milling to an optical backing plate for polishing;
S4, cutting the forming body glass formed after the polishing;
S5, coating the forming body glass formed after the cutting; and
S6, inking the forming body glass formed after the coating.

FIG. 1 shows the forming body glass 10 obtained by the hot-press molding of the present embodiment, which has a triangular prism structure 11 and a lens structure 12 that is formed into one piece with the triangular prism structure 11.

In an embodiment, at step S1, the hot-pressing molding is performed with a precision tungsten steel mold, such that the forming body glass after the hot-pressing molding has a y high precision.

In an embodiment, as shown in FIG. 2, at step S2, a surface of the forming body glass 10 opposite to a processing surface is adhered on a tooling 20, and the adhering surface can be flat, and an instant adhesive is used for adhering. As flatness will affect the adhering effect, the adhering surface has a sufficient high flatness. The adhering method in the milling process is matched with the flatness of the product to ensure a consistency in processing designing dimension of products; before milling, a distance from an edge of the adhering surface to an outer diameter of the aspherical surface is confirmed, and set milling and processing size of two right-angle surfaces is determined. A reserving amount of milling process is greater than or equal to 20 μm, which is taken as a processing amount of polishing process. After the milling, during a de-gluing process, the appearance deficiencies of products, such as scratches, chipping, and fractures, are controlled. After the milling is completed, a surface finish Ra of the forming body glass reaches 0.4 μm, which is equivalent to a finish level of ∇8. With such configuration, when inspected with a 3×-6× magnifying glass, no scratches is observed. A geometric shape and surface shape accuracy of the aspherical prism after milling is very close to the requirements of the blueprint. When an angle is detected by a goniometer, no angle error is detected due to that the correction in the subsequent polishing process changes in a wavelength level.

In an embodiment, step S3 includes:
S31, when adhering the forming body glass to the optical backing plate, observing interference fringes with a standard mirror to confirm that a number of interference fringes is within a preset range. In an embodiment, when adhering the forming body glass, the adhering is performed according to the size of the forming body glass, the adhering position of the forming body glass is reasonably arranged according to the specification of a measured size to ensure the accuracy of the angle and the size during the polishing process. After adhering, when observing the interference fringes with a standard mirror, the number of the interference fringes can be controlled within a range of 3 to 5.

In an embodiment, the step S3 includes:
S32, during the polishing process, monitoring a grinding size at time intervals to confirm that the grinding size is within the preset range, for example, monitoring the grinding size every two hours, and measuring the corresponding size with a thickness gauge to ensure that the grinding size is within a reasonable range.

In an embodiment, step S3 includes:
S30, during polishing a surface of 45°, using an optical backing plate of 45°(45°±15″, relative to a measurement reference, a parallel difference between the top and bottom being not more than 10″). With the optical backing plate of 45°, it can be ensured that the surface of 45° is parallel to a polishing disc to ensure polishing accuracy.

As an improvement, at step S3, the polishing process is continuously performed without an off state, that is, the optical backing plate can be removed when without the off state, and the continuous polishing is conducive to temperature balance and protection of the stability of the polishing mold, so as to ensure the surface shape accuracy of the processing prism body (i.e., the forming body glass).

If the prism body is dropped during the polishing process, the polishing disc can be cleaned in time, and the polishing powder is filtered in time, which can avoid poor appearance of the batch of the products.

In the process of separating the optical backing plate after polishing, if an instant adhesive is used for adhering, acetone or ethanol can be used to remove the glue. The way of removing the glue depends on the type of adhering, which is not limited thereto. For example, it is also possible to separate the optical backing plate by boiling at high temperature (about 300°).

After polishing (in an embodiment, low polishing is performed for about 4 hours), the lens is placed in a cleaning processing tooling for cleaning, and then its appearance is checked to ensure that the finished product can enter the next process.

In an embodiment, the S4 includes:
S41, adhering a reference glass plate to a cutting tooling, and cutting out a line mark on the reference glass plate as a reference line, and adhering the forming body glass after polishing to the reference glass plate in alignment with the reference line;
S42, cutting the forming body glass after the polishing with a cutting machine after a glue is cured (for about 30 min); and
S43, after the cutting is completed, removing the glue to obtain the aspherical prism.

As shown in FIG. 3, the aspherical prism structure 30 obtained after milling, polishing, and cutting includes: a first surface 31 and a second surface 32 that are perpendicular to each other, and a reflective surface 33 connecting the first surface 31 with the second surface 32. The first surface 31 is an aspherical surface. In an embodiment, the second surface 32 can also be an aspherical surface, and based on the above method and steps, the process for manufacturing the second surface 32 as an aspherical surface can also be realized.

As an improvement, at step S41, a multi-line cutting machine is used to cut out the line mark, and the multi-line cutting machine is used for cutting.

After the aspherical prism is obtained, it is placed in the cleaning tooling for cleaning, and then its appearance is checked, and the angle and size are measured to ensure the aspherical prism can enter the next process.

In an embodiment, at step S5, according to the requirements of the coating film in the design, the coating process of the anti-reflection film and/or the reflective film is performed, and the coating films meet the requirements for transmittance, refractive index, spectroscopic value, and coating reliability.

In an embodiment, at step S6, the coating process of an ink layer is carried out in a dust-free room according to the design requirements, and an ink proportion and a drying and hardening time are adjusted to ensure that the ink layer will not easily fall off, and the appearance of the inking coating does not have undesirable phenomenon, such as de-inking, lack of ink, uneven ink layer, convex dot, or dirty.

The above described are merely implementations of the present disclosure. It should be noted here that those of ordinary skill in the art may make improvements without departing from the concept of the present disclosure, but such improvements should fall within the protection scope of the present disclosure.

What is claimed is:

1. A method for manufacturing an aspherical prism, comprising:
step S1, forming a prism and a lens into one piece to obtain a forming body glass by using a hot-pressing molding;
step S2, adhering the forming body glass to a tooling, and performing a right-angle surface milling on the forming body glass according to a preset size while reserving a processing amount for a polishing process;
step S3, adhering the forming body glass formed after the right-angle surface milling to an optical backing plate for polishing;
step S4, cutting the forming body glass formed after the polishing;
step S5, coating the forming body glass formed after the cutting; and
step S6, inking the forming body glass formed after the coating.

2. The method for manufacturing the aspherical prism as described in claim 1, wherein at step S1, the hot-pressing molding is performed with a precision tungsten steel mold.

3. The method for manufacturing the aspherical prism as described in claim 1, wherein at step S2, the processing amount for the polishing process is greater than or equal to 20 μm, and a milling surface finish level reaches ∇8.

4. The method for manufacturing the aspherical prism as described in claim 1, wherein the step S3 comprises:
step S31, when adhering the forming body glass to the optical backing plate, observing interference fringes with a standard mirror to confirm that a number of the interference fringes is within a preset range.

5. The method for manufacturing the aspherical prism as described in claim 4, wherein the step S3 comprises:
step S32, during the polishing process, monitoring a grinding size at time intervals to confirm that the grinding size is within a preset range.

6. The method for manufacturing the aspherical prism as described in claim 1, wherein the step S3 comprises:
step S30, during polishing a surface of 45°, using an optical backing plate of 45°.

7. The method for manufacturing the aspherical prism as described in claim 1, wherein at step S3, the polishing process is continuously performed without an off state.

8. The method for manufacturing the aspherical prism as described in claim 1, wherein the step S4 comprises:
step S41, adhering a reference glass plate to a cutting tooling, and cutting out a line mark on the reference glass plate as a reference line, and adhering the forming body glass after polishing to the reference glass plate in alignment with the reference line;
step S42, cutting the forming body glass after the polishing with a cutting machine after a glue is cured; and
step S43, after the cutting is completed, removing the glue to obtain the aspherical prism.

9. The method for manufacturing the aspherical prism as described in claim 8, wherein, at step S41, a multi-line cutting machine is used to cut out the line mark, and the multi-line cutting machine is used for cutting.

10. An aspherical prism, comprising:
a first surface and a second surface that are perpendicular to each other; and
a reflective surface connecting the first surface with the second surface,
wherein at least one of the first surface or the second surface is an aspherical surface, and
the aspherical prism is manufactured by a method for manufacturing an aspherical prism, and
the method comprises:
step S1, forming a prism and a lens into one piece to obtain a forming body glass by using a hot-pressing molding,
step S2, adhering the forming body glass to a tooling, and performing a right-angle surface milling on the forming body glass according to a preset size while reserving a processing amount for a polishing process,
step S3, adhering the forming body glass formed after the right-angle surface milling to an optical backing plate for polishing,
step S4, cutting the forming body glass formed after the polishing,
step S5, coating the forming body glass formed after the cutting, and
step S6, inking the forming body glass formed after the coating.

11. The aspherical prism as described in claim 10, wherein at step S1, the hot-pressing molding is performed with a precision tungsten steel mold.

12. The aspherical prism as described in claim 10, wherein at the S2, the processing amount for the polishing process is greater than or equal to 20 μm, and a milling surface finish level reaches ∇8.

13. The aspherical prism as described in claim 10, wherein the step S3 comprises:
step S31, when adhering the forming body glass to the optical backing plate, observing interference fringes with a standard mirror to confirm that a number of the interference fringes is within a preset range.

14. The aspherical prism as described in claim 13, wherein the step S3 comprises:
step S32, during the polishing process, monitoring a grinding size at time intervals to confirm that the grinding size is within a preset range.

15. The aspherical prism as described in claim 10, wherein the step S3 comprises:
step S30, during polishing a surface of 45°, using an optical backing plate of 45°.

16. The aspherical prism as described in claim 10, wherein at step S3, the polishing process is continuously performed without an off state.

17. The aspherical prism as described in claim 10, wherein the step S4 comprises:
step S41, adhering a reference glass plate to a cutting tooling, and cutting a line mark on the reference glass plate as a reference line, and adhering the forming body glass after polishing to the reference glass plate in alignment with the reference line;
step S42, cutting the forming body glass after the polishing with a cutting machine after a glue is cured; and
step S43, after the cutting is completed, removing the glue to obtain the aspherical prism.

18. The aspherical prism as described in claim 17, wherein, at step S41, a multi-line cutting machine is used to cut the line mark, and the multi-line cutting machine is used for cutting.
